(19) United States
(12) Patent Application Publication
(10) Pub. No.: US 2009/0168897 A1
(43) Pub. Date: Jul. 2, 2009

(54) WIRELESS COMMUNICATION DEVICE

(75) Inventor: Masafumi MATSUMURA, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 12/336,425

(22) Filed: Dec. 16, 2008

(30) Foreign Application Priority Data
Dec. 26, 2007 (JP) 2007-334790

(51) Int. Cl. H04N 11/02

(52) U.S. Cl. 375/240.25; 375/E07.027

(57) ABSTRACT

According to one embodiment, a wireless communication device includes: a storage section configured to store compressed data; a decompression section configured to decompress the compressed data to generate non-compressed data; a wireless communication section configured to wirelessly transmit one of the compressed data and the non-compressed data; and a power control section configured to control power supply to the decompression section. The power control section interrupts power supply to the decompression section when the wireless communication section transmits the compressed data.

### CROSS-REFERENCE TO RELATED APPLICATIONS

This application is based upon and claims the benefit of priority from Japanese Patent Application No. 2007-334790, filed on Dec. 26, 2007, the entire contents of which are incorporated herein by reference.

### BACKGROUND

1. Field

One embodiment of the invention relates to a wireless communication device of a transmitting side in a wireless communication system.

2. Description of the Related Art

In general, in a wireless communication system, moving image data is compressed and kept by moving image compression techniques such as MPEG-2, H.264, and the like. In this type of wireless communication system, there are two methods for transmitting moving image data. In the first method, a wireless communication device of a transmitting side directly transmits compressed moving image data and a wireless communication device of a receiving side expands the compressed moving image data and reproduce them (see JP-A-9-224198, for instance). In the second method, the wireless communication device of the transmitting side transmits compressed moving image data after expanding thereof and the wireless communication device of the receiving side directly reproduces decompressed (non-compressed) moving image data.

According to the first method, the wireless communication device of the transmitting side may be able to transmit the moving image data at a relatively low megabit-order transmission rate, whereas the wireless communication device of the receiving side needs to expand the compressed moving data. On the other hand, according to the second method, the wireless communication device of the receiving side may directly reproduce the non-compressed moving image data, whereas the wireless communication device of the transmitting side needs to expand the compressed moving image data and requires a relatively high gigabit-order transmission rate.

By the way, in recent years, in the wireless communication system, a wireless communication scheme using millimeter waves of a 60 GHz band has been proposed. It is hopeful that the wireless communication scheme is used in a wireless network within 10 meters, different from a wireless LAN, a Wireless Personal Area Network (WPAN), or the like. Since this wireless communication scheme may make it possible to achieve a gigabit-order transmission rate in a scheme of conventional wireless LAN or Bluetooth, it is hopeful to make a moving image transmission cable of a DVI, an HDMI, or the like in which high-rate communication is possible in the existing wired communication, wireless. When this wireless communication scheme is used, it is possible to realize a relatively high gigabit-order transmission rate.

However, the wireless communication device of the transmitting side needs to have an expansion circuit to expand the compressed moving image data. Since this type of expansion circuit requires high power, it interferes with low power consumption of the wireless communication device of the transmitting side. When the wireless communication device is a portable device, the low power consumption is desired.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary configuration diagram showing a configuration of one embodiment of a wireless communication system;

FIG. 2 is an exemplary circuit block diagram showing a configuration of a wireless communication device related to an embodiment of the present invention;

FIG. 3 is an exemplary circuit block diagram showing a configuration of a wireless communication device of a counterpart in the embodiment;

FIG. 4 is an exemplary flowchart showing an operation of the wireless communication device in the embodiment; and

FIG. 5 is a circuit block diagram showing a configuration of a wireless communication device of a comparative example of the present invention.

### DETAILED DESCRIPTION

Various embodiments according to the invention will be described hereinafter with reference to the accompanying drawings. In general, according to one embodiment of the invention, a wireless communication device includes: a storage section configured to store compressed data; a decompression section configured to decompress the compressed data to generate non-compressed data; a wireless communication section configured to wirelessly transmit one of the compressed data and the non-compressed data; and a power control section configured to control power supply to the decompression section. The power control section interrupts power supply to the decompression section when the wireless communication section transmits the compressed data.

Hereinafter, preferred embodiments of the present invention will be described in detail with reference to the accompanying drawings. In the drawings, the same or similar elements are assigned the same reference numerals and signs.

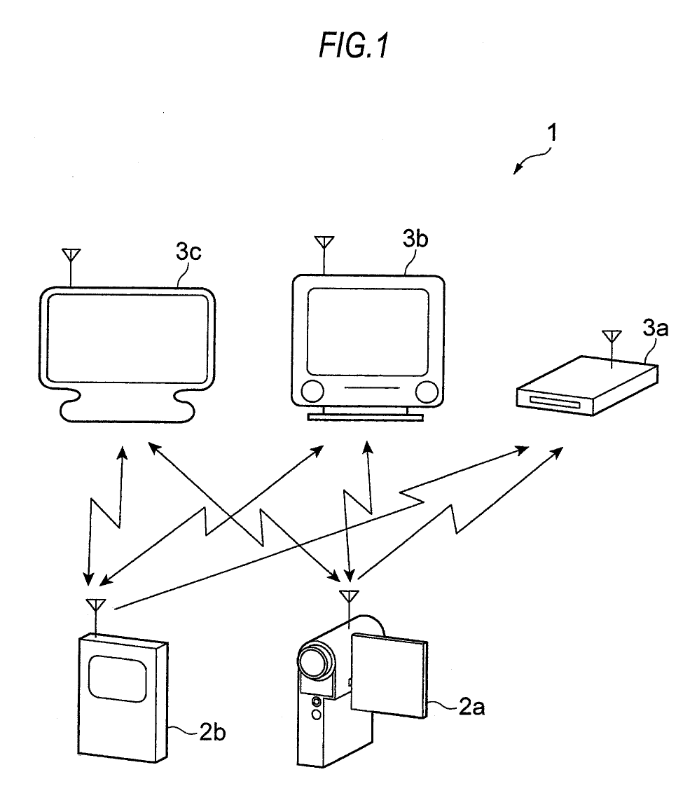

FIG. 1 is an exemplary configuration diagram showing a configuration of one embodiment of a wireless communication system. A wireless communication system 1 shown in FIG. 1 includes wireless communication devices 2a, 2b and wireless communication devices 3a, 3b, 3c as counterparts.

The wireless communication devices 2a, 2b wirelessly perform data communication with the wireless communication devices 3a to 3c. For example, the wireless communication device 2a is a video camera for capturing a moving image, and the wireless communication device 2b is a media player for reproducing the moving image. The wireless communication devices 2a, 2b are not limited to the moving image and can be an audio for recording or reproducing a sound, and the like. Furthermore, they are not limited to the above-mentioned portable AV device and various devices can be applied if the devices wirelessly perform data communication.

The wireless communication devices 3a to 3c wirelessly perform data communication with the wireless communication devices 2a, 2b. The wireless communication device 3a is, for example, a DVD recorder for recording and reproducing the moving image, which can reproduce the moving image after receiving and expanding compressed moving image data. The wireless communication device 3b is, for example, a digital television for reproducing a moving image, which can reproduce the moving image after receiving and expanding compressed moving image data and can receive, and can directly reproduce, non-compressed moving image data. The wireless communication device 3c is, for example, a monitor for reproducing a moving image, which can receive, and directly reproduce, non-compressed moving image data.

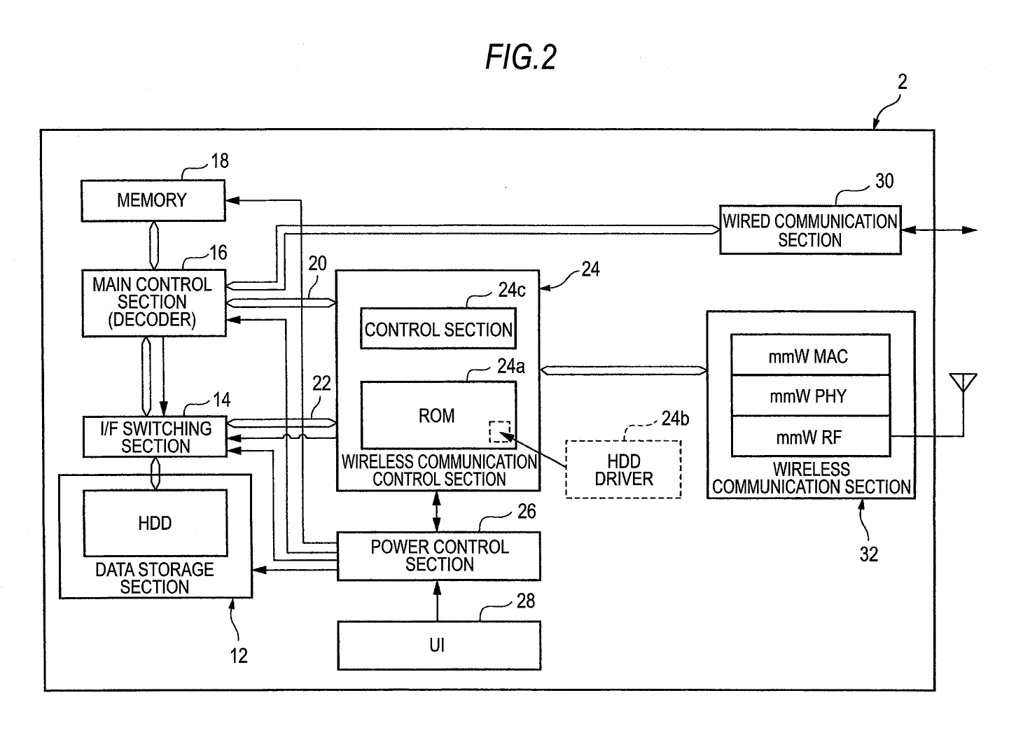

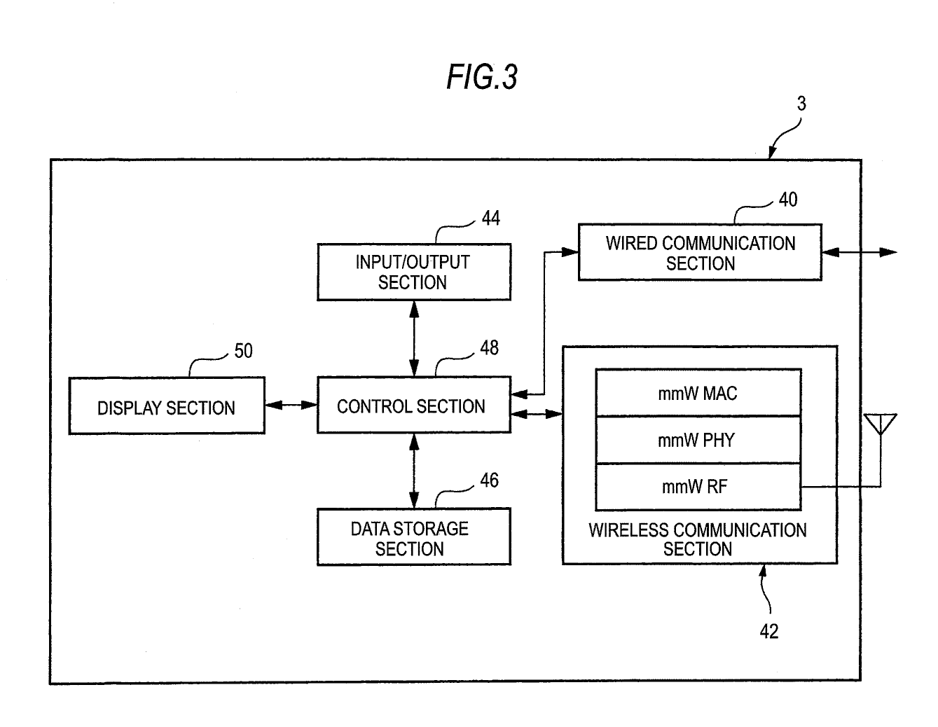

Next, a wireless communication device 2 is shown as one embodiment of the above-mentioned wireless communication devices 2a, 2b, and a wireless communication device 3 is shown as one embodiment of the above-mentioned counterpart wireless communication devices 3a˜3c. FIG. 2 is an exemplary circuit block diagram showing a configuration of a wireless communication device in an embodiment of the present invention, and FIG. 3 is an exemplary circuit block diagram showing a configuration of a counterpart wireless communication device in the embodiment.

First, the wireless communication device 2 shown in FIG. 2 will be described in detail. The wireless communication device 2 includes a data storage section 12, an interface switching section (I/F switching section) 14, a main control section 16, a memory 18, a main internal bus 20, a local bus 22, a wireless communication control section 24, a power control section 26, a user interface (UI) 28, a wired communication section 30, and a wireless communication section 32.

The data storage section 12 stores a program required to operate the wireless communication device 2 and various data of compressed moving image data and the like. The data storage section 12 outputs the various data to the interface switching section 14. For example, the data storage section 12 is a flash ROM, an HDD, or the like.

In response to a command from the wireless communication control section 24, the interface switching section 14 selects whether to output various data from the data storage section 12 to a bus of the main control section 16 side or a bus of the wireless communication control section 24 side. For example, in these buses, a USB, Integrated Drive Electronics (IDE), Advanced Technology Attachment (ATA), and the like are used.

The main control section 16 functions as a decoder, that is, expansion section, by reading the program from the data storage section 12, and generates non-compressed moving image data by expanding the compressed moving image data from the data storage section 12. Moreover, when the non-compressed moving image data is reproduced or wired communication is performed, the main control section 16 performs the overall control of the wireless communication device 2. The main control section 16 uses the memory 18 to temporarily keep the non-compressed moving image data when the compressed moving image data is decoded or perform the overall control of the wireless communication device 2. For example, a Central Processing Unit (CPU) or the like is used as the main control section 16.

The main internal bus 20 is a bus that connects the main control section 16 and the wireless communication control section 24, and is a bus to be used when the main control section 16 transmits the non-compressed moving image data. For example, as the main internal bus 20, a bus for transmitting a video signal such as deep color of 24/30/36-bit RGB/YCbCr 4:4:4, 8/10/12-bit YCbCr 4:2:2 (ITU.601 and ITU.656), or the like, or a bus for transmitting a digital signal based on an HDMI is used.

The local bus 22 is a bus that connects the interface switching section 14 and the wireless communication control section 24, that is, a bus for directly connecting the data storage section 12 and the wireless communication control section 24, and is a bus to be used when transmitting the compressed moving image data.

The wireless communication control section 24 functions as acquisition section to acquire information regarding data communication capability or data processing capability of the wireless communication device 3 via the wireless communication section 32.

For example, the information regarding the data communication capability is information showing whether or not a transmission of each of the compressed moving image data and the non-compressed moving image data is supported in a physical layer level or logical link layer of a wireless communication scheme used in a wireless communication section 42 of the counterpart wireless communication device 3 to be described later. Specifically, the information regarding the data communication capability can be provided as information of whether or not the non-compressed moving image data transmission can be supported at a communication rate, information of the presence or absence of contents protection technology suitable for a wireless transmission of the non-compressed moving image data or compressed moving image data, or the like. Since an interleave operation on each of the compressed moving image data and the non-compressed moving image data is used to add burst error resilience on a wireless transmission line in the physical layer level, information regarding the presence or absence of a function thereof is included in the information regarding the data communication capability.

On the other hand, the information regarding the data processing capability is capability information showing whether or not the counterpart wireless communication device 3 to be described later can expand and display the compressed moving image data or can receive and display the non-compressed moving image data.

The wireless communication control section 24 functions as determination section to determine whether or not the compressed moving image data can be transmitted to the wireless communication device 3 based on the acquired information regarding the data communication capability or data processing capability. The wireless communication control section 24 outputs a determination result to the power control section 26.

When wireless communication is performed, the wireless communication control section 24 controls and accesses the wireless communication section 32 or the power control section 26, the interface switching section 14, and the data storage section 12. The wireless communication control section 24 has a storage section 24a, an HDD driver 24b, and a control section 24c.

The storage section 24a stores a program or data for operating the wireless communication control section 24. For example, the storage section 24a uses a ROM, a RAM, or the like. In this embodiment, the storage section 24a also has the HDD driver 24b. The HDD driver 24b stores a program for controlling the local bus 22 or the data storage section 12 in wireless communication, and for being used by the control section 24c. The control section 24c reads the program or data from the storage section 24a and the HDD driver 24b to perform the control of the wireless communication control section 24.

The power control section 26 receives a wireless communication start request from the user interface 28 and supplies power to the wireless communication control section 24. Moreover, the power control section 26 functions as power control section and selects a supply destination and performs power supply based on a result of determining whether or not the compressed moving image data can be transmitted to the counterpart wireless communication device 3 counterpart in the wireless communication control section 24. For example, the power control section 26 supplies power to only the data storage section 12 and the interface switching section 14 when the compressed moving image data can be transmitted to the counterpart wireless communication device 3, and also supplies power to the main control section 16 and the memory 18 in addition to the data storage section 12 and the interface switching section 14 when the compressed moving image data cannot be transmitted. That is, when the counterpart wireless communication device 3 can expand the compressed moving image data and can receive the compressed moving image data, the power control section 26 interrupts power supply to the main control section 16 and the memory 18. In other words, the power control section 26 interrupts the power supply to the main control section 16 and the memory 18 when transmitting the compressed moving image data.

The user interface 28 is used as operation section that makes an instruction when a user desires to wirelessly transmit a moving image. For example, the user interface 28 is a switch, a button, or the like.

The wired communication section 30 is used when establishing a wired connection with the counterpart wireless communication device 3. For example, the wired communication section 30 can be connected to an HDMI cable, a LAN cable, or the like.

The wireless communication section 32 is used when making a wireless connection with the counterpart wireless communication device 3. For example, the wireless communication section 32 is a wireless module using a millimeter wave, a UWB, or the like.

Next, the counterpart wireless communication device 3 shown in FIG. 3 will be described. The counterpart wireless communication device 3 is provided with a wired communication section 40, the wireless communication section 42, an input/output section 44, a data storage section 46, a control section 48, and a display section 50.

The wired communication section 40 is used when making a wired connection with the wireless communication device 2. For example, the wired communication section 40 can be connected to an HDMI cable, a LAN cable, or the like.

The wireless communication section 42 is used when wirelessly communicating with the wireless communication device 2. For example, the wireless communication section 42 is a wireless module using a millimeter wave, a UWB, or the like.

An input/output section 44 is used as operation section at which the user instructs an operation to the wireless communication device 3. For example, the input/output section 44 is a button, a remote control, or the like.

The data storage section 46 stores a program or data for operating the wireless communication device 3. For example, in the data storage section 46, a ROM, a RAM, an HDD, or the like is used.

The control section 48 performs the overall control of the wireless communication device 3. When the wireless communication device 3 is provided with an expansion function, the control section 48 functions as a decoder. For example, as the control section 48, a CPU or the like is applicable.

The display section 50 displays a moving image by receiving non-compressed moving image data from the control section 48. For example, the display section 50 is a Liquid Crystal Display (LCD), a plasma display, or the like.

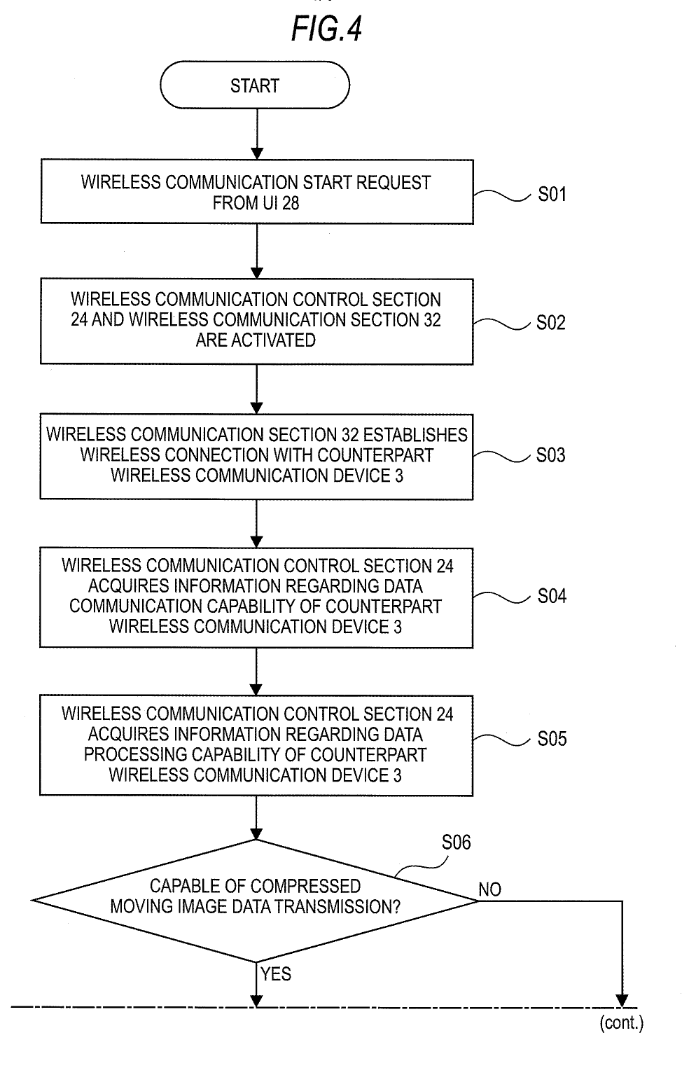

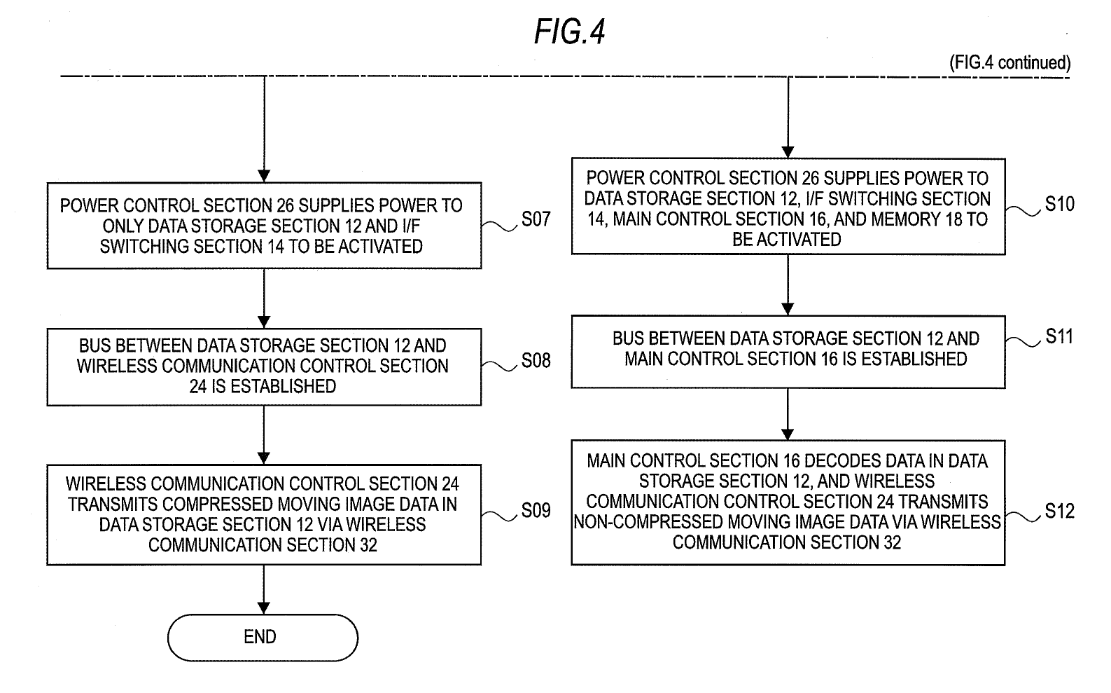

Next, an operation of a wireless communication system 1 of this embodiment will be described. FIG. 4 is an exemplary flowchart showing an operation of a wireless communication device in the embodiment.

The user performs an instruction with the user interface 28 when desiring to reproduce, in the counterpart wireless communication device 3 using wireless communication, compressed moving image data kept in the data storage section 12 of the wireless communication device 2. When receiving a wireless communication start request from the user interface 28 (S01), the power control section 26 supplies power to the wireless communication control section 24, and the control section 24c is activated in the wireless communication control section 24. Then, the wireless communication control section 24 functions as the acquisition section, activates the wireless communication section 32, and starts a search of a connection destination (S02). At this time, the user inputs power of the wireless communication device 3 desired to be connected by the input/output section 44, and instructs the designation and allowance of a wireless connection such that the wireless communication section 32 of the wireless communication device 2 and the wireless communication section 42 of the counterpart wireless communication device 3 establish the wireless connection through processing of connection authentication or the like (S03).

After the wireless connection is established, the wireless communication control section 24 acquires the information regarding data communication capability of the wireless communication section 42 in the counterpart wireless communication device 3 via the wireless communication section 32. Specifically, the wireless communication control section 24 exchanges information regarding the presence or absence of capability of receiving non-compressed moving image data and the presence or absence of capability of receiving compressed moving image data in the wireless communication section 42 in the counterpart wireless communication device 3 (S04).

Next, the wireless communication control section 24 acquires information regarding data processing capability of the control section 48 in the counterpart wireless communication device 3 via the wireless communication section 32. Specifically, the wireless communication control section 24 exchanges capability information of whether the wireless communication device 3 can receive, expand, and display the compressed moving image data or can receive and display the non-compressed moving image data (S05). For example, the wireless communication device 3 keeps the information regarding the data processing capability of the control section 48 in the data storage section 46.

For example, when the wireless communication device 3 is the DVD recorder 3a, information indicating that compressed moving image data can be received, expanded, and displayed is kept in the data storage section 46. When the wireless communication device 3 is the digital television 3b, information indicating that compressed moving image data can be received, expanded, and displayed or non-compressed moving image data can be received and displayed is kept in the data storage section 46. When the wireless communication device 3 is the monitor 3c, information indicating that non-compressed moving image data can be received and displayed is kept in the data storage section 46.

Next, the wireless communication control section 24 functions as the determination section and determines whether or not compressed moving image data can be transmitted based on the acquired information regarding the data communication capability and data processing capability (S06).

When it is determined that the compressed moving image data can be transmitted, the power control section 26 supplies power to only the data storage section 12 and the interface switching section 14, and activates only the data storage section 12 and the interface switching section 14. That is, when the wireless communication device 3 can expand the compressed moving image data and can receive the compressed moving image data, the power control section 26 interrupts power supply to the main control section 16 and the memory 18. In other words, the power control section 26 interrupts the power supply to the main control section 16 and the memory 18 when transmitting the compressed moving image data (S07). Thereafter, the wireless communication control section 24 switches the interface switching section 14 such that the local bus 22 is usable. Thereby, in the wireless communication control section 24, the control section 24c executes a stored program, such that it is possible to directly access a section storing actual data of the data storage section 12 using the local bus 22 after initializing and controlling the local bus 22 (S08).

At this time, when the user desires to reproduce or select moving image data, an instruction is made in a remote control or the like through the input/output section 44 in the wireless communication device 3 by employing a method standardized in Digital Living Network Alliance (DLAN), and the wireless communication control section 24 transmits compressed moving image data stored in the data storage section 12 via the wireless communication section 32 by performing wireless communication between the control section 48 in the wireless communication device 3 and the control section 24c in the wireless communication control section 24 of the wireless communication device 2 (S09).

When the wireless communication device 3 is the digital television 3b, the wireless communication device 3 can switch selection to receive non-compressed moving image data from compressed moving image data by making an instruction by a remote control or the like through the input/output section 44 in the wireless communication device 3.

In the wireless communication device 3, the control section 48 expands the compressed moving image data received through the wireless communication section 42 to generate non-compressed moving image data, and the display section 50 displays the non-compressed moving image data.

On the other hand, when it is determined that the compressed moving image data cannot be transmitted, the wireless communication device 2 transmits the non-compressed moving image data. At this time, the power control section 26 supplies power to the main control section 16 and the memory 18 in addition to the data storage section 12 and the interface switching section 14, and usually activates the wireless communication device 2 (S10). Thereafter, the wireless communication control section 24 switches the interface switching section 14 such that the bus of the main control section 16 side is usable. Thereby, the main control section 16 can directly access the data storage section 12 (S11).

The main control section 16 expands compressed moving image data designated by the user to generate non-compressed moving image data and transmits the non-compressed moving image data to the wireless communication control section 24 via the main internal bus 20. Thereafter, the wireless communication control section 24 transmits the non-compressed moving image data via the wireless communication section 32 (S12).

At this time, when the user desires to reproduce or select moving image data, an instruction is made by a remote control or the like through the input/output section 44 in the wireless communication device 3 by employing Consumer Electronics Control (CEC) standardized in an HDMI. When the HDMI is wirelessly made in the wireless communication section, a command defined by the CEC can be realized by performing wireless communication between the control section 48 placed in the wireless communication device 3 and the control section 24c in the wireless communication control section 24 of the wireless communication device 2 (S12).

In the wireless communication device 3, the control section 48 directly displays the non-compressed moving image data received via the wireless communication section 42 to the display section 50.

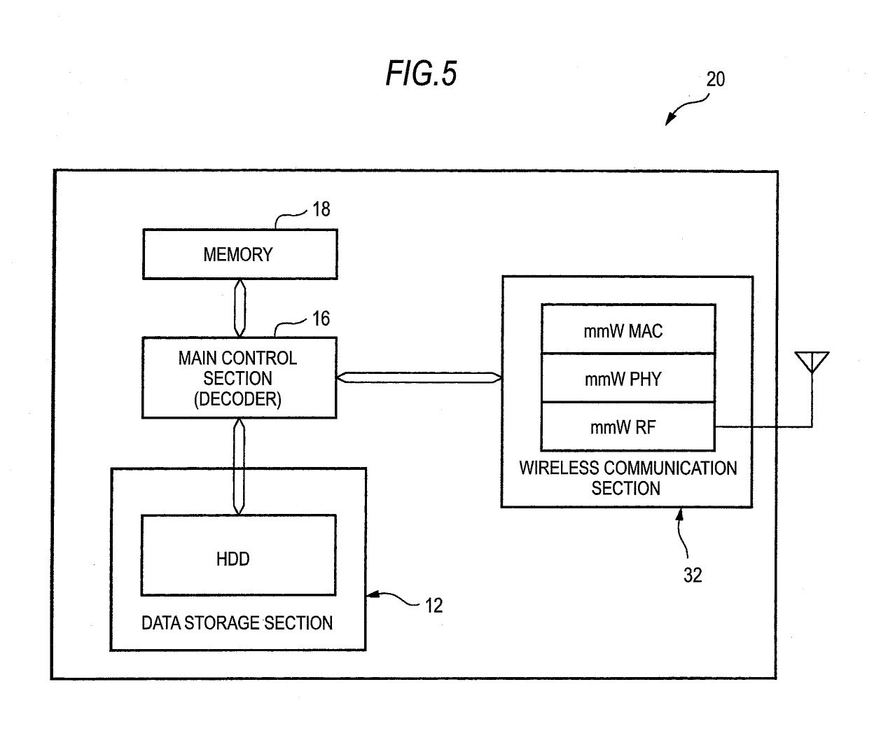

Here, FIG. 5 shows an exemplary circuit block diagram of a conventional wireless connection device 20. Since the wireless communication section 32 is connected to the main control section 16 in the wireless communication device 20 shown in FIG. 5, the main control section 16 is activated even when expanding compressed moving image data and transmitting non-compressed moving image data and even when directly transmitting the compressed image data. This interferes low power consumption.

However, since the power control section 26 does not supply power to the main control section 16 functioning as the expansion section when transmitting the compressed moving image data according to the wireless communication device 2 of this embodiment, the main control section 16 is not activated, such that lower power consumption is possible.

By the way, in a case of a wired connection, the connection is made between the wired connection sections 30, 40 using, for example, a LAN cable, a USB cable, or the like, when the compressed moving image data is transmitted, and the connection is made between the wired connection sections 30, 40 using, for example, an HDMI cable or the like, when the non-compressed moving image data is transmitted. In the case of the wired connection as described above, the user should select the compressed moving image data transmission or the non-compressed moving image data transmission according to a type of cable, that is, a communication scheme.

Also in the conventional wireless connection device 20 as described above, the compressed moving image data transmission or the non-compressed moving image data transmission should be determined by a wireless communication standard used by the user or selected by the user himself/herself in a setting operation. When the wireless communication scheme used by the user is not supported, or even when the scheme is supported but a physical layer or logical link layer is not suitable to transmit non-compressed moving image data, or by other reasons, it is complicated that the user performs the setting operation.

On the other hand, according to the wireless communication device 2 in this embodiment, the wireless communication control section 24 functions as the acquisition section to acquire the information regarding data communication capability and information regarding data processing capability of the wireless communication device 3, and transmits compressed moving image data when the wireless communication device 3 is capable of receiving the compressed moving image data and is capable of expanding the compressed moving image data. Since non-compressed moving image data is transmitted when the wireless communication device 3 is not capable of receiving the compressed moving image data or is not capable of expanding the compressed moving image data. Therefore the wireless communication device 2 can transmit moving image data according to the data communication capability and the data processing capability of the counterpart wireless communication device 3 without user's distinction between the compressed moving image data and the non-compressed moving image data.

The present invention is not limited to this embodiment, and can be variously modified. For example, in this embodiment, the wireless communication device 2 for transmitting moving image data has been illustrated, but the present invention is not limited to the moving image data and is applicable to a wireless communication device that transmits various data such as sound data and the like.

In this embodiment, the portable wireless communication device 2 has been illustrated, but the present invention is not limited to a portable device and is applicable to various wireless communication devices.

In this embodiment, the power control section 26 performs power supply control based on the data communication capability and data processing capability, but can perform power supply control based on only the data processing capability. In general, in the wireless communication device, there is provided a wireless communication section having data communication capability according to data processing capability of the control section.

What is claimed is:

1. A wireless communication device comprising:
a storage module configured to store compressed data;
a decompression module configured to decompress the compressed data to generate non-compressed data;
a transmitter configured to wirelessly transmit one of the compressed data and the non-compressed data; and
a power controller configured to control power supply to the decompression module,
wherein the power controller is configured to interrupt power supply to the decompression module when the transmitter transmits the compressed data.

2. The device of claim 1 further comprising an acquisition module configured to receive information regarding data processing capability of a counterpart wireless communication device,
wherein the power controller is configured to interrupt the power supply to the decompression module based on the information regarding data processing capability when the counterpart wireless communication device is capable of decompressing the compressed data.

3. The device of claim 2,
wherein the acquisition module further configured to receive information regarding data communication capability of a counterpart wireless communication device, and
wherein the power controller is configured to interrupt the power supply to the decompression module based on the information regarding data processing capability and the information regarding data communication capability when the counterpart wireless communication device is capable of decompressing the compressed data and receiving the compressed data.

4. The device of claim 2, wherein the information regarding data processing capability comprises information indicative of whether the counterpart wireless communication device is capable of decompressing the compressed data.

5. The device of claim 3, wherein the information regarding data processing capability comprises information indicative of whether the counterpart wireless communication device is capable of decompressing the compressed data.

6. The device of claim 3, wherein the information regarding data communication capability comprises information indicative of whether the counterpart wireless communication device supports compressed data transmission in a physical layer level and a logical link layer in a wireless communication scheme.
